(19) United States
(12) Patent Application Publication
(10) Pub. No.: US 2017/0348073 A1
(43) Pub. Date: Dec. 7, 2017

(54) DENTAL IMPLANTS HAVING GOLDEN RATIO

(71) Applicant: CORTEX DENTAL IMPLANTS INDUSTRIES LTD., SHLOMI (IL)

(72) Inventors: MEIR MAMRAEV, RISHON LEZION (IL); AVIAD DOTAN, MOSHAV KORANIT (IL)

(21) Appl. No.: 15/540,662

(22) PCT Filed: Dec. 30, 2015
(86) PCT No.: PCT/IL2015/051268

§ 371 Date: Jun. 29, 2017

(30) Foreign Application Priority Data
Dec. 31, 2014 (IL) 236541

(51) Int. Cl. A61C 8/00

(52) U.S. Cl. CPC A61C 8/0024; A61C 8/0089; A61C 8/0025; A61C 8/0037

(57) ABSTRACT

A dental implant that comprises a top section having a C first length, an intermediate section having a second length, and a bottom section having a third length, wherein the first length corresponds to the third length by a preset ratio, wherein the third length corresponds to the sum of the first length and the second length by the preset ratio, and wherein the preset ratio is in the range of 1.5-1.7.

### FIELD OF THE INVENTION

The present invention relates to dental implants. More particularly, the present invention relates to usage of dental implants provided in accordance with the golden ratio.

### BACKGROUND OF THE INVENTION

Dental implants today are provided in many different configurations, as some have specific features for performing different tasks, for instance some implants are dedicated for maintaining enhanced stability once implanted. Each dental implant (having a relatively small size, typically ˜9 mm) usually has a neck top section, a cylindrical intermediate section, and an apex bottom section. Typically, the cylindrical intermediate section and the apex bottom section of the implant are threaded, sometimes with different types of threads.

Since different implants (for instance as provided by different manufacturers) do not maintain a constant ratio between these sections, such implants may appear to be identical as the disparity between these sections becomes difficult to identify when viewed by the naked eye. Specifically, with threaded implants it can become difficult to distinguish changes in the length of a certain section as an indication of a different implant.

Therefore, even an expert physician (e.g. a dental surgeon) performing dental operations and facilitating dental implants can sometimes use the wrong implant due to the small size of all implants and their similar structure, thus perhaps causing unnecessary harm or injuries to a patient.

There is therefore a need for a system capable of providing dental implants with different configurations, while eliminating possible misidentification between different implants.

### SUMMARY OF THE INVENTION

In a first aspect of the invention a dental implant is provided, the implant comprising:
a top section having a first length;
an intermediate section having a second length; and
a bottom section having a third length,
   wherein the first length corresponds to the third length by a preset ratio, wherein the third length corresponds to the sum of the first length and the second length by the preset ratio, and wherein the preset ratio is in the range of 1.5-1.7.

In some embodiments, the preset ratio is 1.618 with a predetermined deviation.

In some embodiments, the dental implant further comprises at least one first flute having a fourth length and configured to allow enhanced stability during implantation.

In some embodiments, the dental implant further comprises at least one second flute having a fifth length and configured to allow enhanced stability during implantation.

In some embodiments, the fourth length corresponds to the sum of the second length and the third length by the preset ratio.

In some embodiments, the fifth length corresponds to the sum of the second length and the third length by the preset ratio.

In some embodiments, the fourth length and the fifth length are equal to each other.

In some embodiments, the preset ratio is 1.618 with a predetermined deviation.

In some embodiments, the second length and the third length are equal to each other.

In some embodiments, the dental implant further comprises a depression with a socket for receiving a rotary tool configured to allow rotation of the dental implant during implantation.

In a second aspect of the invention a method for implanting a dental implant within osseous tissue or bone is provided, the method comprising the steps of:
providing a top section having a first length;
providing an intermediate section having a second length;
providing a bottom section having a third length;
providing at least one first flute having a fourth length;
providing at least one second flute having a fifth length; and
rotating said dental implant during an implant procedure,
   wherein said at least one first flute and said at least one second flute member also cut into the osseous tissue or bone so as to support said implant, wherein the first length corresponds to the third length by a preset ratio, wherein the third length corresponds to the sum of the first length and the second length by the preset ratio, wherein the fifth length corresponds to the sum of the second length and the third length by the preset ratio, wherein the fifth length corresponds to the sum of the second length and the third length by the preset ratio, and wherein the preset ratio is in the range of 1.5-1.7.

In some embodiments, the preset ratio is 1.618 with a predetermined deviation.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates a frontal view of a commercially available dental implant.

FIG. 2A illustrates a frontal view of a golden ratio dental implant, according to an exemplary embodiment.

FIG. 2B illustrates a frontal view of a golden ratio dental implant.

FIG. 3A illustrates a perspective view of a golden ratio dental implant with a total length of 6 mm, according to an exemplary embodiment.

FIG. 3B illustrates a perspective view of a golden ratio dental implant with a total length of 11 mm, according to an exemplary embodiment.

FIG. 3C illustrates a perspective view of a golden ratio dental implant with a total length of 16 mm, according to an exemplary embodiment.

### DETAILED DESCRIPTION OF THE INVENTION

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For clarity, non-essential elements were omitted from some of the drawings.

In mathematics, two quantities “X”, “Y” are defined in a golden ratio if their ratio is the same as the ratio of their sum to the larger of the two quantities

$$\frac{X + Y}{X} = \frac{X}{Y} {=}^{def} ϕ$$

The Greek letter phi (φ) represents the empirical golden ratio, φ=1.61803 . . .

The golden ratio frequently appears in geometry and is used in the formation of golden rectangles and golden sections that are considered to be aesthetically pleasing. The golden ratio has also been used to analyze the proportions of natural objects as well as man-made systems such as architecture, music and financial markets.

It would therefore be advantageous to provide dental implants having sections with a structure according to the golden ratio, such that different implants are easily distinguished by the physician. Furthermore, a dental implant having a structure according to the golden ratio may have enhanced stability and withstand greater pressure forces applied onto the implant.

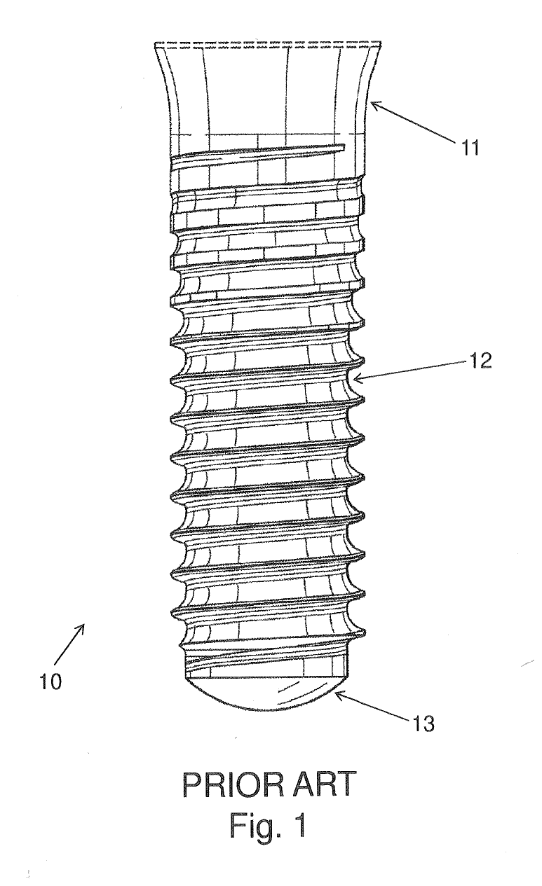

FIG. 1 illustrates a frontal view of a commercially available dental implant 10. The dental implant 10 has a neck top section 11, a cylindrical intermediate section 12, and an apex bottom section 13. It is appreciated that it can be difficult to distinguish such implants 10 when they are provided in different lengths (e.g. with one mm difference), wherein each section may also have a changed length individually from the other sections.

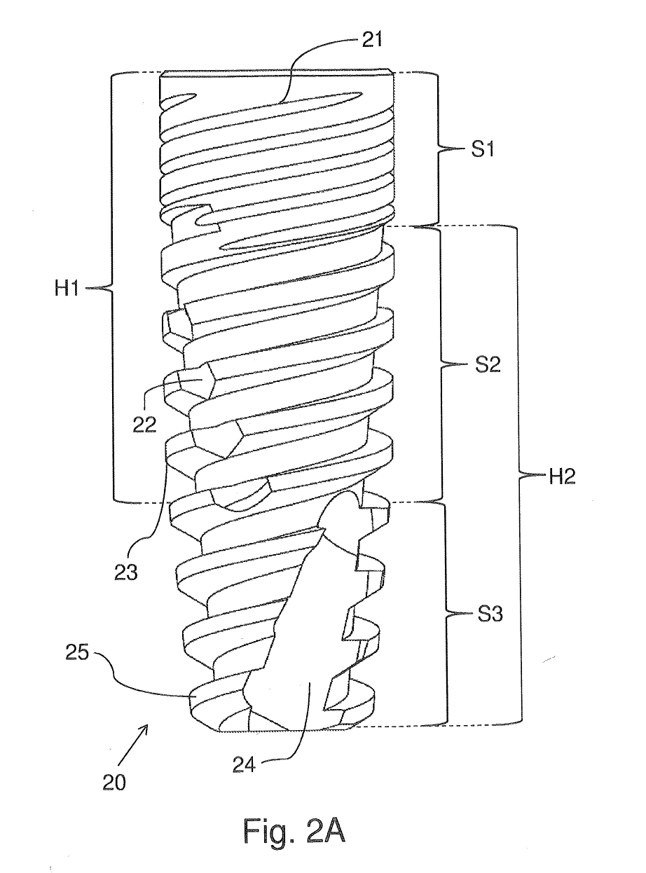

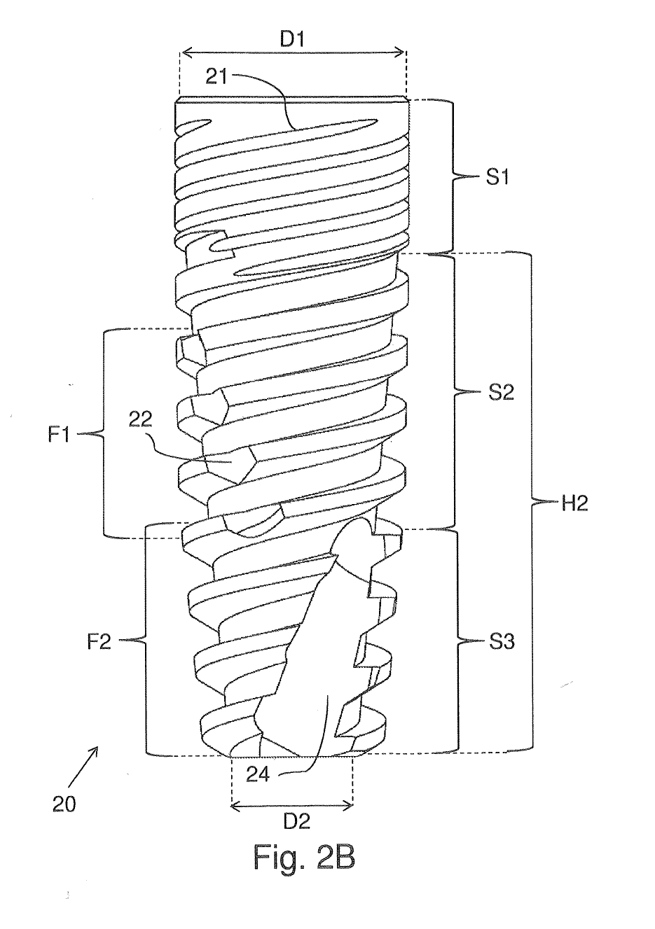

FIGS. 2A and 2B illustrate a frontal view of a golden ratio dental implant 20. The golden ratio dental implant 20 has a neck top section with a first length “S1”, a cylindrical intermediate section with a second length “S2”, and an apex bottom section with a third length “S3” such that the total length of the golden ratio dental implant 20 is S1+S2+S3. Two additional lengths “H1”,“H2” may be defined as follows: S1+S2 [symbol] H1 , S2+S3 [symbol] H2.

In some embodiments, the length S2 of the cylindrical intermediate section, and the length S3 of the apex bottom section are equal to each other.

With these definitions, the golden ratio dental implant 20 is provided with a structure in accordance with the golden ratio. Specifically:

$$\frac{S 3}{S 1} = \frac{H 2}{S 3} = ϕ ≅ 1.618$$

In a further embodiment, the neck top section S1 has a top thread 21, the cylindrical intermediate section S2 has an intermediate thread 23, and the apex bottom section S3 has a bottom thread 25. For example the top thread 21 may be finer than the intermediate thread 23 and the bottom thread 25. Optionally, the depth of these threads may also be provided in accordance with the golden ratio. In some embodiments, the golden ratio dental implant is provided with a single continuous threading wherein the depth of the thread is unchanged throughout the implant.

Additionally, each golden ratio dental implant 20 may be provided with a plurality of flutes in order to allow facilitation of initial cutting into the bone and/or osseous tissue during implantation. Specifically, an intermediate flute 22 and a bottom flute 24. It is appreciated that while only two flutes are partially shown in the frontal view illustrated in FIGS. 2A-2B, additional flutes may be located in the golden ratio dental implant 20.

In a preferred embodiment, the golden ratio dental implant 20 is further provided with a fluted structure according to the golden ratio. By defining the intermediate flute 22 to have a fourth length “F1”, and the bottom flute 24 to have a fifth length “F2”, the structure of the golden ratio dental implant 20 may provide:

$$\frac{H 2}{F 1} = \frac{H 2}{F 2} = ϕ ≅ 1.618$$

In some embodiments, the length F1 of the intermediate flute 22, and the length F2 of the bottom flute 24 are equal to each other, while having a golden ration corresponding to the length H2 (defined as S2+S3).

It should be noted that in addition to providing an aesthetically pleasing dental implant by creating a structure in accordance with the golden ratio, an enhanced stability may be found in such implants designed using a “natural” structure. For example, similarly to architectural structures build in accordance to the golden ratio.

In a further embodiment, the diameter of the golden ratio dental implant 20 may also be provided with a structure corresponding to the golden ratio. Specifically, providing a golden ratio between a top diameter “D1” and a bottom diameter “D2”.

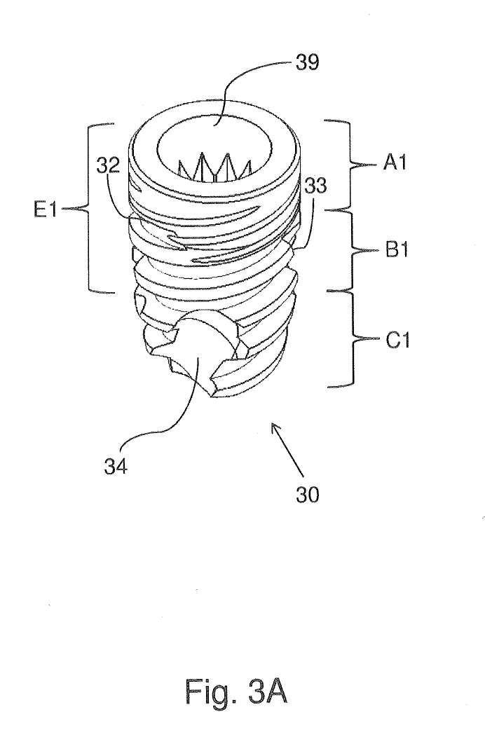

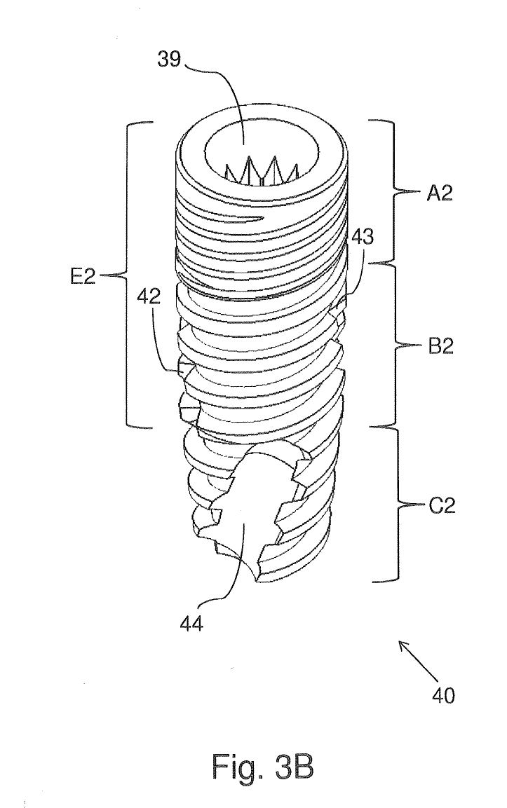

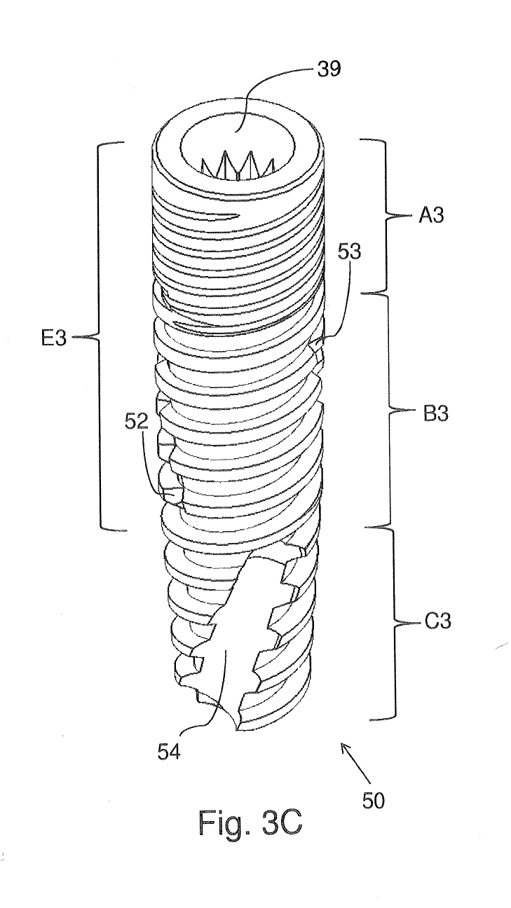

Referring now to FIGS. 3A-3C, these figures show examples of implants provided in accordance with the golden ratio. The golden ratio dental implant may further comprise a depression 39 with a socket for receiving a rotary tool in order to rotate the implant during implantation.

FIG. 3A illustrates a perspective view of a golden ratio dental implant 30 with a total length of ˜6 mm The golden ratio dental implant 30 has a neck top section “A1” with a length of ˜1.46 mm, a cylindrical intermediate section “B1” with a length of ˜2.37 mm, and an apex bottom section “C1” with a length of ˜2.37 mm By defining the length: E1 [symbol] A1+B1, the golden ratio may be achieved in the structure of the golden ratio dental implant 30:

$$\frac{C 1}{A 1} = \frac{E 1}{C 1} = ϕ ≅ 1.618$$

It should be noted that the golden ratio dental implant 30 comprises a first intermediate flute 32, and a second intermediate flute 33 opposite of the first intermediate flute 32. Additionally, the golden ratio dental implant 30 comprises a first bottom flute 34 while a second bottom flute (opposite of the first bottom flute) is not shown in FIG. 3A.

FIG. 3B illustrates a perspective view of a golden ratio dental implant 30 with a total length of 11 mm The golden ratio dental implant 40 has a neck top section “A2” with a length of 2.6 mm, a cylindrical intermediate section “B2” with a length of 4.2 mm, and an apex bottom section “C2” with a length of 4.2 mm.

FIG. 3C illustrates a perspective view of a golden ratio dental implant 30 with a total length of 16 mm The golden ratio dental implant 50 has a neck top section “A3” with a length of 3.78 mm, a cylindrical intermediate section “B3” with a length of 6.11 mm, and an apex bottom section “C3” with a length of 6.11 mm.

Similarly to the golden ratio structure of embodiment 30 illustrated in FIG. 3A, by defining the lengths: E2 [symbol] A2+B2 , E3 [symbol] A3+B3 , the golden ratio may be achieved in the structure of the golden ratio dental implants:

$$\frac{C 2}{A 2} = \frac{E 2}{C 2} = \frac{C 3}{A 3} = \frac{E 3}{C 3} = ϕ ≅ 1.618$$

Furthermore, the golden ratio dental implant 40 comprises a first intermediate flute 42, and a second intermediate flute 43 opposite of the first intermediate flute 42. Additionally, the golden ratio dental implant 40 comprises a first bottom flute 44 while a second bottom flute (opposite of the first bottom flute) is not shown in FIG. 3B. Similarly, the golden ratio dental implant 50 comprises a first intermediate flute 52, and a second intermediate flute 53 opposite of the first intermediate flute 52. Additionally, the golden ratio dental implant 50 comprises a first bottom flute 54 while a second bottom flute (opposite of the first bottom flute) is not shown in FIG. 3C. It is appreciated that a dental implant having flutes in corresponding opposite sites may have enhanced stability for implantation.

When such golden ratio dental implant (for instance as shown in FIGS. 3A-3C) are used by a physician, the risk of misidentification between different implants is eliminated, since even a slight change (e.g. ˜1 mm) in the structure of the implant may now be easily visible to the physician. This improvement occurs as a result of the constant ratio between the different sections of the golden ratio dental implant. It should be noted that in some embodiments, other constant ratios (beside the golden ratio) may be used for the structure of the dental implant.

It should be noted that while the golden ratio (φ≅1.618) was described above, other ratios may also be employed to achieve the same effect within a predetermined deviation. Specifically, structural ratios in the range of 1.5-1.7.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A dental implant, comprising:
a top section having a first length;
an intermediate section having a second length; and
a bottom section having a third length,
wherein the first length corresponds to the third length by a preset ratio, wherein the third length corresponds to the sum of the first length and the second length by the preset ratio, and wherein the preset ratio is in the range of 1.5-1.7.

2. The dental implant of claim 1, wherein the preset ratio is 1.618 with a predetermined deviation.

3. The dental implant of claim 1, further comprising at least one first flute having a fourth length and configured to allow enhanced stability during implantation.

4. The dental implant of claim 3, further comprising at least one second flute having a fifth length and configured to allow enhanced stability during implantation.

5. The dental implant of claim 4, wherein the fourth length corresponds to the sum of the second length and the third length by the preset ratio.

6. The dental implant of claim 4, wherein the fifth length corresponds to the sum of the second length and the third length by the preset ratio.

7. The dental implant of claim 4, wherein the fourth length and the fifth length are equal to each other.

8. The dental implant of claim 5, wherein the preset ratio is 1.618 with a predetermined deviation.

9. The dental implant of claim 4, wherein the second length and the third length are equal to each other.

10. The dental implant of claim 1, further comprising a depression with a socket for receiving a rotary tool configured to allow rotation of the dental implant during implantation.

11. A method for implanting a dental implant within osseous tissue or bone, the method comprising the steps of:
providing a top section having a first length;
providing an intermediate section having a second length;
providing a bottom section having a third length;
providing at least one first flute having a fourth length;
providing at least one second flute having a fifth length; and
rotating said dental implant during an implant procedure,
wherein said at least one first flute and said at least one second flute member also cut into the osseous tissue or bone so as to support said implant, wherein the first length corresponds to the third length by a preset ratio, wherein the third length corresponds to the sum of the first length and the second length by the preset ratio, wherein the fifth length corresponds to the sum of the second length and the third length by the preset ratio, wherein the fifth length corresponds to the sum of the second length and the third length by the preset ratio, and wherein the preset ratio is in the range of 1.5-1.7.

12. The method of claim 11, wherein the preset ratio is 1.618 with a predetermined deviation.
